(19) United States
(12) Patent Application Publication
(10) Pub. No.: US 2002/0144150 A1
(43) Pub. Date: Oct. 3, 2002

(54) Providing access control via the layer manager

(76) Inventors: Douglas LaVell Hale, Orem, UT (US); Michael D. Wright, Sandy, UT (US); Merrill Kay Smith, Riverton, UT (US); David O. Cox, Orem, UT (US); Kyle Bryan Seegmiller, Salt Lake City, UT (US); Jonathan Brett Wood, Spanish Fork, UT (US)

Correspondence Address: SAWYER LAW GROUP LLP, P.O. Box 51418, Palo Alto, CA, 94303, US

(21) Appl. No.: 09/825,676

(22) Filed: Apr. 3, 2001

(51) Int. Cl. G06F 11/30

(52) U.S. Cl. 713/201

(57) ABSTRACT

A method and system for access control within a protocol stack includes: receiving a request to perform an operation at a layer of the protocol stack; calling an access mediator; determining if the request is to be granted based upon a predetermined security policy by the access mediator; and providing the determination by the access mediator. The Access Mediator is a software which embodies the rules of a predetermined security policy. In the preferred embodiment, the security policy is subject (people) based. The rules of the security policy determines which subjects can have access to which objects (data) to perform a requested operation (read/write). The Access Mediator is called to determine whether or not a request to perform an operation is to be granted based upon the security policy. In this manner, access control is provided within the protocol stack.

### FIELD OF THE INVENTION

The present invention relates to protocol stacks, and more particularly to security in the protocol stacks.

### BACKGROUND OF THE INVENTION

Security is a continual concern in the wireless networking industry. Conventionally, security mechanisms provide access control at the packet level. “Firewalls” are examples of such a security mechanism. Firewalls filter packets based on their addresses and port numbers. All packets with the address and the port number are blocked. However, these mechanisms do not provide access control within a protocol stack, i.e., between the layers of the protocol stack. They are not able to authenticate users at the stack layer level.

Accordingly, there exists a need for a method and system for providing access control within a protocol stack. The method and system should provide authentication of users at the stack layer level. The present invention addresses such a need.

### SUMMARY OF THE INVENTION

A method and system for access control within a protocol stack includes: receiving a request to perform an operation at a layer of the protocol stack; calling an access mediator; determining if the request is to be granted based upon a predetermined security policy by the access mediator; and providing the determination by the access mediator. The Access Mediator is a software which enforces the rules of a predetermined security policy. In the embodiment, the security policy is subject (people) based. The rules of the security policy determines which subjects can have access to which objects (data) to perform a requested operation (e.g. read/write). The Access Mediator is called to determine whether or not a request to perform an operation is to be granted based upon the security policy. In this manner, access control is provided within the protocol stack.

### BRIEF DESCRIPTION OF THE FIGURES

FIG. 1 is a flow chart illustrating a preferred embodiment of a method for providing access control within a protocol stack in accordance with the present invention.

FIG. 2 illustrates a first preferred embodiment of a protocol stack which utilizes the method for providing access control within the protocol stack in accordance with the present invention.

FIG. 3 is a flowchart illustrating the method for providing access control as utilized by the first preferred embodiment of the protocol stack in accordance with the present is invention.

FIG. 4 illustrates a second preferred embodiment of a protocol stack which utilizes the method for providing access control within the protocol stack in accordance with the present invention.

FIG. 5 is a flowchart illustrating the method for providing access control as utilized by the second preferred embodiment of the protocol stack in accordance with the present invention.

### DETAILED DESCRIPTION

The present invention provides a method and system for providing access control within a protocol stack. The following description is presented to enable one of ordinary skill in the art to make and use the invention and is provided in the context of a patent application and its requirements. Various modifications to the preferred embodiment will be readily apparent to those skilled in the art and the generic principles herein may be applied to other embodiments. Thus, the present invention is not intended to be limited to the embodiment shown but is to be accorded the widest scope consistent with the principles and features described herein.

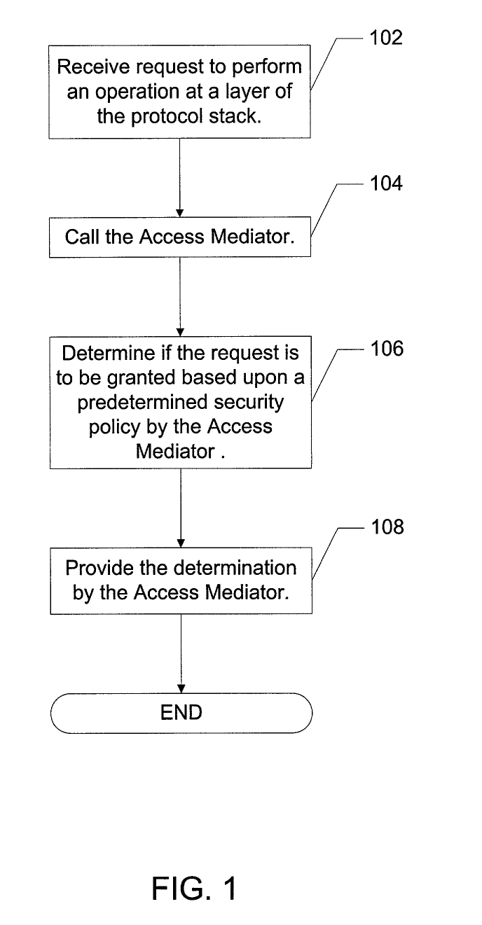

To more particularly describe the features of the present invention, please refer to FIGS. 1 through 5 in conjunction with the discussion below.

The preferred embodiment of the present invention provides access control within a protocol stack through an Access Mediator. The Access Mediator is a software which enforces the rules of a predetermined security policy. In the preferred embodiment, the security policy is subject (people) based. The rules of the security policy determines which subjects can have access to which objects (data) to perform a requested operation (e.g. read/write).

FIG. 1 is a flow chart illustrating a preferred embodiment of a method for providing access control within a protocol stack in accordance with the present invention. First, a request to perform an operation at a layer of a protocol stack is received, via step 102. In the preferred embodiment, the operation is to be performed on an object by a particular subject. Next, the Access Mediator is called, via step 104. In the preferred embodiment, the appropriate information is passed to the Access Mediator in the call. The appropriate information includes the subject's identity, the object's identity, and the requested operation. The Access Mediator determines whether or not the request is to be granted based upon a predetermined security policy, via step 106. Then, the Access Mediator provides the determination, via step 108. If the Access Mediator determines that the subject can access the object to perform the requested operation, then the operation is allowed to occur at the layer of the protocol stack. If the Access Mediator determines that the subject cannot access the object to perform the requested operation, then the operation is blocked.

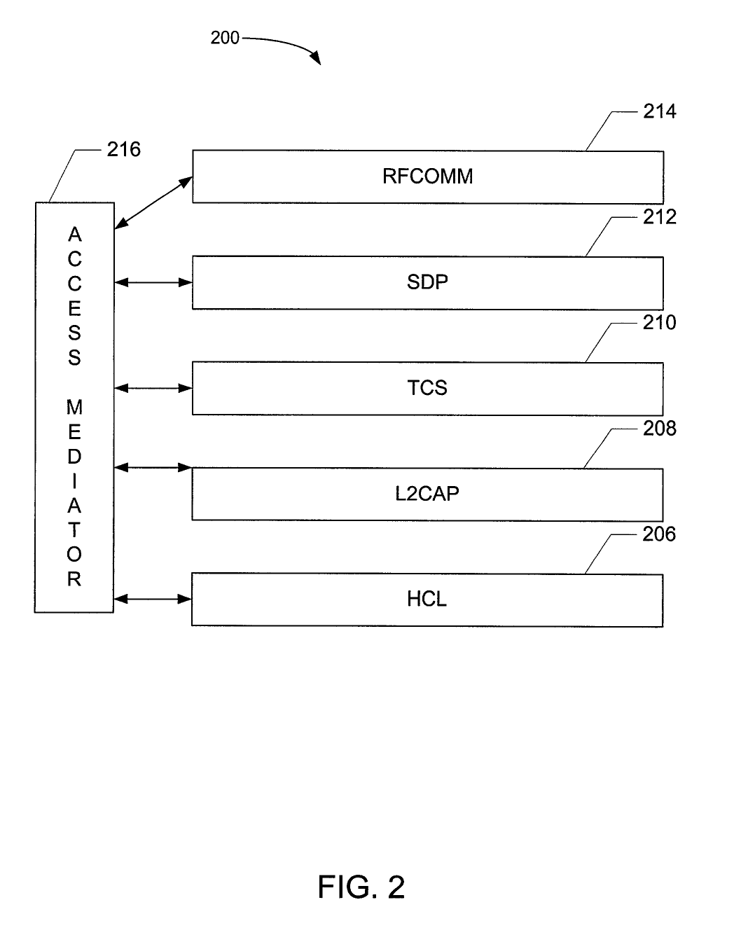

FIG. 2 illustrates a first preferred embodiment of a protocol stack which utilizes the method for providing access control within the protocol stack in accordance with the present invention. In this embodiment, the protocol stack 200 is a Bluetooth protocol stack. The stack 200 includes a Host Controller Interface (HCI) layer 206, a Logical Link Control and Adaptation Protocol (L2CAP) layer 208, a Telephony Control Protocol Specification (TCS) layer 210, a Service Discovery Protocol (SDP) layer 212, and a RFCOMM protocol layer 214.

The HCI layer 206 provides a command interface which accepts communications over the physical bus (not shown). The L2CAP layer 208 supports higher level protocol multiplexing, packet segmentation and reassembly, and the conveying of quality of service information.

The TCS layer 210 provides call control and signaling of voice channels. The SDP layer 212 provides a means for applications to discover which services are provided by or available through a device. It also allows applications to determine the characteristics of those available services. The RFCOMM protocol layer 214 provides emulation of serial ports over the L2CAP layer 208.

Each layer 206-214 of the stack 200 may call the Access Mediator 216 in accordance with the present invention.

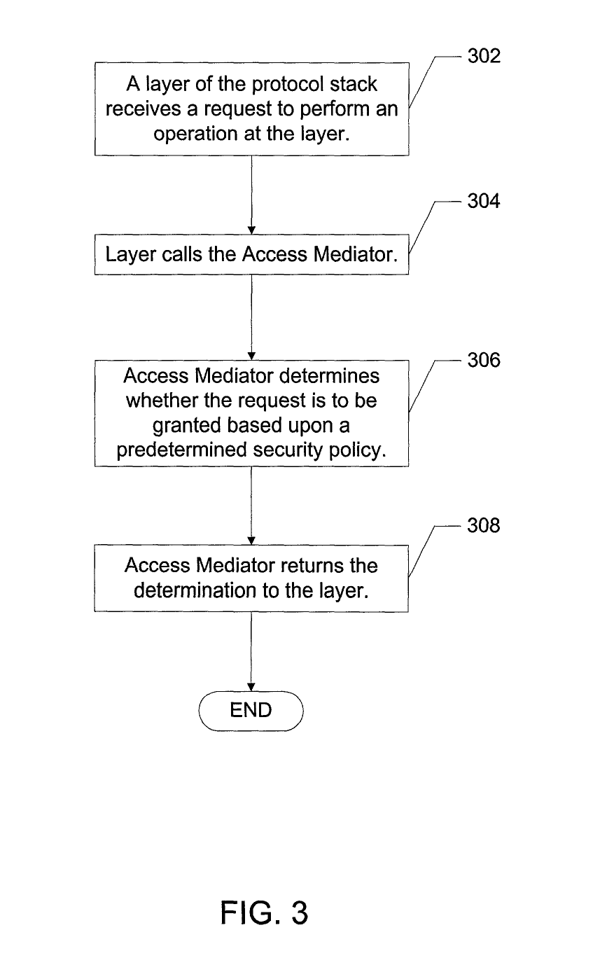

FIG. 3 is a flowchart illustrating the method for providing access control as utilized by the first preferred embodiment of the protocol stack in accordance with the present invention. First, a layer of the protocol stack 200 receives a request to perform an operation at the layer, via step 302. In this embodiment, the operation is to be performed on an object by a particular subject. The layer then calls the Access Mediator, via step 304. In calling the Access Mediator 216, the layer passes the subject's identity, the object's identity, and the requested operation. The Access Mediator 216 determines whether the request is to be granted based upon a predetermined security policy, via step 306. Then, the Access Mediator 216 returns the determination to the layer, via step 308. If the Access Mediator 216 determines that the subject can access the object to perform the requested operation, then the operation is allowed to be performed at the layer. If the Access Mediator 216 determines that the subject cannot access the object to perform the requested operation, then the operation is blocked.

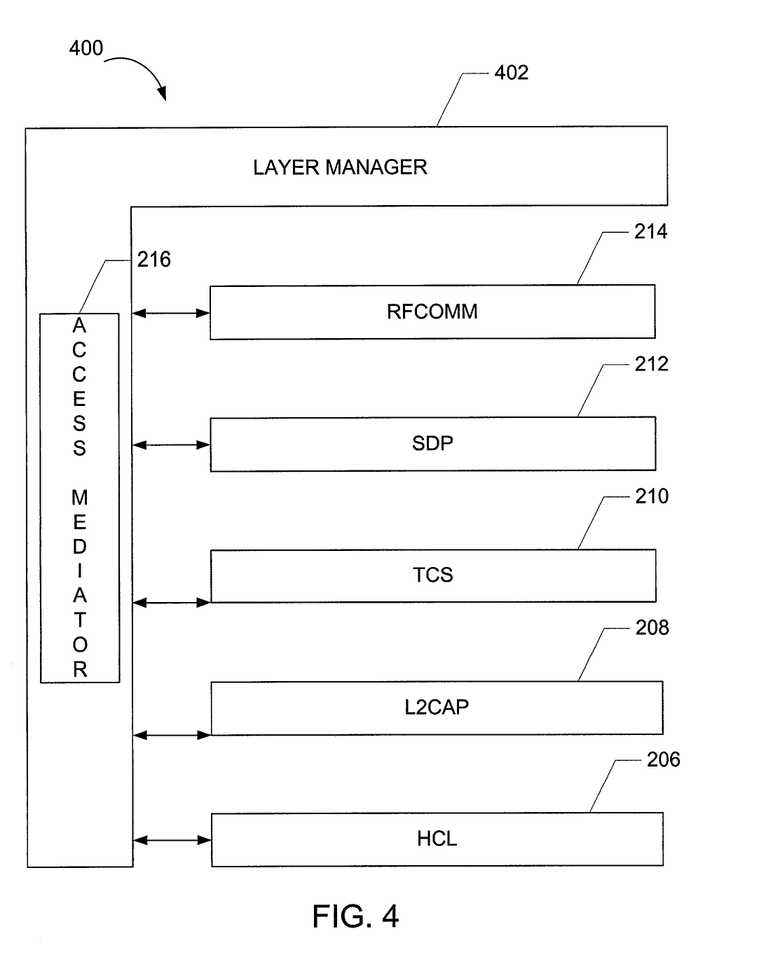

FIG. 4 illustrates a second preferred embodiment of a protocol stack which utilizes the method for providing access control within the protocol stack in accordance with the present invention. The protocol stack 400, in addition to the layers 206-214 described in conjunction with FIG. 2, comprises a Layer Manager 402 which interfaces with each layer 206-214. The Layer Manager 402 handles the data flow to the layers 206-214. The Layer Manager 402 allows each layer 206-214 to process data without the need to have knowledge of which layers reside directly “above” and “below” them. Each layer concerns itself only with whether the data is to travel “up” or “down” the stack 400. Each layer receives its data from the Layer Manager 402, and when it is done processing the data, it gives the data back to the Layer Manager 402. The Layer Manager 402 then routes the data to the next layer.

In this embodiment, the Access Mediator 216 is implemented in the Layer Manager 402. In this manner, the advantages provided by the Layer Manager 402 is realized in providing access control within the stack 400.

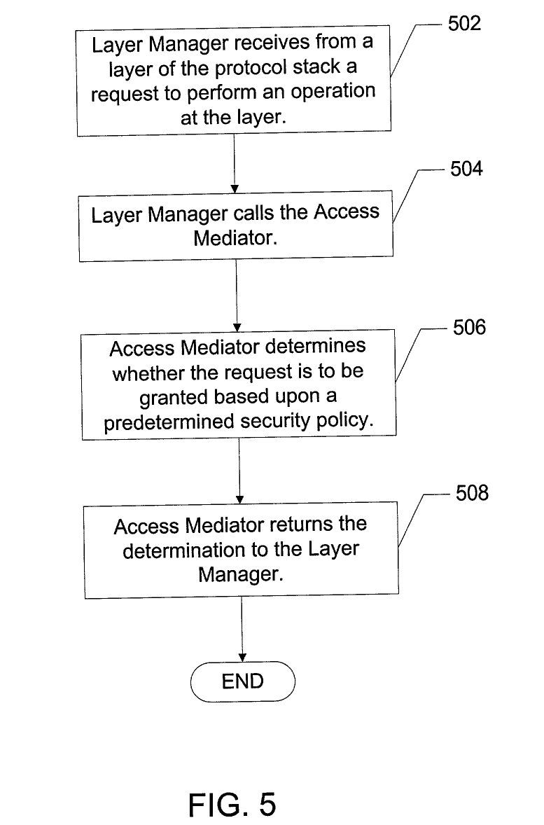

FIG. 5 is a flowchart illustrating the method for providing access control as utilized by the second preferred embodiment of the protocol stack in accordance with the present invention. First, the Layer Manager 402 receives a request from a layer of the protocol stack 400 to perform an operation at the layer, via step 502. In this embodiment, the operation is to be performed on an object by a particular subject. The Layer Manager 402 then calls the Access Mediator 216, via step 504. In calling the Access Mediator 216, the Layer Manager 402 passes the subject's identity, the object's identity, and the requested operation. The Access Mediator 216 determines whether the request is to be granted based upon a predetermined security policy, via step 506. Then, the Access Mediator 216 returns the determination to the Layer Manager 402, via step 508. If the Access Mediator 216 determines that the subject can access the object to perform the requested operation, then the operation is allowed to be performed at the layer. If the Access Mediator 216 determines that the subject cannot access the object to perform the requested operation, then the operation is blocked.

By implementing the Access Mediator 216 in the Layer Manager 402, the stack layers 206-214 need not be aware of the Access Mediator 216, or even that there is a security policy at all. Awareness of the Access Mediator 216 is only required of the Layer Manager 402. Since the stack layers 206-214 need not be aware of the Access Mediator 216, they also do not disrupt the Access Mediator 216, resulting in a more secure protocol stack.

Although the present invention is described in the context of the Bluetooth protocol stack, it may be applied to other protocol stacks without departing from the spirit and scope of the present invention.

A method and system which provides access control within a protocol stack has been described. The access control is provided through an Access Mediator. The Access Mediator is a software which embodies the rules of a predetermined security policy. In the preferred embodiment, the security policy is subject (people) based. The rules of the security policy determines which subjects can have access to which objects (data) to perform a requested operation (read/write). The Access Mediator is called to determine whether or not a request to perform an operation is to be granted based upon the security policy. If the Access Mediator determines that the request is to be granted, then the operation is allowed to be performed at a stack layer. If the Access Mediator determines that the request is not to be granted, then the operation is blocked. In this manner, authentication of subjects or access control is provided within the protocol stack.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A method for providing access control in a protocol stack, comprising the steps of:
(a) receiving a request to perform an operation at a layer of the protocol stack;
(b) calling an access mediator;
(c) determining if the request is to be granted based upon a predetermined security policy by the access mediator; and
(d) providing the determination by the access mediator.

2. The method of claim 1, wherein the receiving step (a) comprises:
(a1) receiving the request by the layer to perform the operation on an object by a subject at the layer of the protocol stack.

3. The method of claim 1, wherein the calling step (b) comprises:
(b1) calling the access mediator by the layer.

4. The method of claim 1, wherein the providing step (d) comprises:
(d1) returning the determination by the access mediator to the layer.

5. The method of claim 1, wherein the receiving step (a) comprises:
(a1) receiving the request by a layer manager to perform the operation on an object by a subject at the layer of the protocol stack.

6. The method of claim 5, wherein the layer manager interfaces with each layer of the protocol stack, wherein the layer manager handles data flow to each layer of the protocol stack.

7. The method of claim 1, wherein the calling step (b) comprises:
(b1) calling the access mediator by a layer manager.

8. The method of claim 7, wherein the access mediator is implemented in the layer manager.

9. The method of claim 1, wherein the providing step (d) comprises:
(d1) returning the determination by the access mediator to a layer manager.

10. The method of claim 1, wherein the calling step (b) further comprises:
(b1) passing a subject's identity, an object's identity, and a requested operation to the access mediator.

11. The method of claim 1, further comprising:
(e) allowing the operation to be performed at the layer if the determination is to grant the request.

12. The method of claim 1, further comprising:
(e) blocking the operation if the determination is to not grant the request.

13. A method for providing access control in a protocol stack, comprising the steps of:
(a) receiving a request by a layer of the protocol stack to perform an operation at the layer;
(b) calling an access mediator by the layer;
(c) determining if the request is to be granted based upon a predetermined security policy by the access mediator; and
(d) providing the determination by the access mediator to the layer.

14. A method for providing access control in a protocol stack, comprising the steps of:
(a) receiving a request by a layer manager to perform an operation at a layer of the protocol stack;
(b) calling an access mediator by the layer manager;
(c) determining if the request is to be granted based upon a predetermined security policy by the access mediator; and
(d) providing the determination by the access mediator to the layer manager.

15. A system, comprising:
a plurality of layers of a protocol stack; and
an access mediator, wherein each layer of the protocol stack may call the access mediator to determine if a request to perform an operation at a layer of the protocol stack is to be granted.

16. A system, comprising:
a plurality of layers of a protocol stack; and
a layer manager, wherein the layer manager is interfaced with each of the plurality of stack components, wherein the layer manager comprises an access mediator, wherein layer manager may call the access mediator to determine if a request to perform an operation at a layer of the protocol stack is to be granted.

17. A computer readable medium with program instructions for providing access control in a protocol stack, comprising the steps of:
(a) receiving a request to perform an operation at a layer of the protocol stack;
(b) calling an access mediator;
(c) determining if the request is to be granted based upon a predetermined security policy by the access mediator; and
(d) providing the determination by the access mediator.
